(19) United States
(12) Patent Application Publication
(10) Pub. No.: US 2008/0095879 A1
(43) Pub. Date: Apr. 24, 2008

(54) MOLD LOCKING DEVICE AND MOLDS USING THE SAME

(75) Inventor: CHIEN-SHENG TU, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/617,080

(22) Filed: Dec. 28, 2006

(30) Foreign Application Priority Data
Oct. 20, 2006 (CN) 200610063216.8

(51) Int. Cl. B29C 35/00

(52) U.S. Cl. 425/451.9; 425/595

(57) ABSTRACT

A mold locking device (10) includes a leader pin (11) and a leader pin bushing (12). The leader pin includes at least one receiving hole (111) defined in an outer surface thereof and at least one spring-loaded ball bearing (112) received in the at least one receiving hole. The spring-loaded ball bearing includes a coil spring (112a) and a ball bearing (112b). The coil spring has one end connected with the leader pin and the other end connected with the ball bearing. A portion of the ball bearing extends beyond the outer surface of the leader pin. The leader pin bushing is used for insertion of the leader pin therein. The leader pin bushing further includes a groove (121) defined in an inner surface for receiving the portion of the at least one spring-loaded ball bearing. A mold (1) is also provided. The mold includes a male mold part (20), a female mold part (30) and the above-described mold locking device.

### BACKGROUND OF THE INVENTION

1. Field of the Invention

The invention relates generally to mold locking devices and molds using the same, and more particularly to a reliable mold locking device and mold using the same.

2. Description of Related Art

Molding apparatuses, such as injection molding, compression molding and transfer molding machines, usually have at least one stationary die and at least one movable die. For example, during operation of an injection molding machine, an upper die of a mold is moved downwards by a closing cylinder onto a lower die. In a closed position, the mold a pressure of 6,000 to 7,500 N is applied. It is sometimes required that the machine be temporarily shut down with the movable die assembly of the machine held in a certain position with respect to the stationary die assembly.

However, a related injection mold is equipped with a mold locking device to delay the opening of the mold. In the case of an injection mold having such a mold locking device, it is desirable that the movable die assembly of the mold is held at rest in a certain position whenever the die assemblies of the mold is allowed to open up either accidentally or for any purpose. A typical mold locking device uses a pin and plastic rings to achieve a delay function when the mold starts to open. The plastic rings are hitched on the pin. The mold locking device is used to connect the die assemblies of the mold. When the mold is opened up, the plastic ring can temporarily stop the separation of the die assemblies of the mold.

However, the typical mold locking devices have some drawbacks. For example, the plastic ring can become worn during opening and closing of the mold. Therefore, the delay function of the mold locking device fails to work normally. This kind of the mold locking device is not so reliable.

What is needed, therefore, is a reliable mold locking device and a mold using the same.

### SUMMARY OF THE INVENTION

A mold locking device is provided. In one embodiment, the mold locking device includes a leader pin and a leader pin bushing. The leader pin includes at least one receiving hole defined in an outer surface thereof and at least one spring-loaded ball bearing received in the at least one receiving hole. The spring-loaded ball bearing includes a coil spring and a ball bearing secured to the coil spring. The coil spring is received in the receiving hole. The coil spring has one end connected with the leader pin and the other end connected with the ball bearing. A portion of the ball bearing extends beyond the outer surface of the leader pin. The leader pin bushing is used for insertion of the leader pin therein. The leader pin bushing further includes a groove defined in an inner surface for receiving the portion of the at least one spring-loaded ball bearing.

A mold is provided. In another embodiment, the mold includes a male mold part, a female mold part and a mold locking device. The mold locking device includes a leader pin and a leader pin bushing. The leader pin includes at least one receiving hole defined in an outer surface thereof and at least one spring-loaded ball bearing received in the at least one receiving hole. A portion of the at least one spring-loaded ball bearing extends beyond the outer surface of the leader pin. The leader pin bushing is used for insertion of the leader pin therein. The leader pin bushing further includes a groove defined in an inner surface for receiving the portion of the at least one spring-loaded ball bearing. The male mold part defines a through hole therein for extension of the leader pin therethrough. The female mold part defines a hole therein for accommodating the leader pin bushing therein.

Advantages and novel features of the present mold locking device and mold using the same will become more apparent from the following detailed description of preferred embodiments when taken in conjunction with the accompanying drawings.

### BRIEF DESCRIPTION OF THE DRAWING

The components in the drawing are not necessarily drawn to scale, the emphasis instead being placed upon clearly illustrating the principles of the present invention.

FIG. 1 is a schematic, cross-sectional view of a mold locking device in accordance with a first preferred embodiment of the present invention;

FIG. 2 is a detailing, partial cross-sectional view of a leader pin ball bearing of the mold locking device of FIG. 1;

FIG. 3 is a detailing, cross-sectional view of a leader pin bushing of the mold locking device of FIG. 1; and

FIG. 4 is a schematic, cross-sectional view of a mold using the mold locking device of FIG. 1 in accordance with a second preferred embodiment of the present invention.

Corresponding reference characters indicate corresponding parts. The exemplifications set out herein illustrate at least one preferred embodiment of the present mold locking device and mold using the same, in one form, and such exemplifications are not to be construed as limiting the scope of the invention in any manner.

### DETAILED DESCRIPTION OF THE INVENTION

Reference will now be made to the drawings to describe embodiments of the present mold locking device and mold using the same in detail.

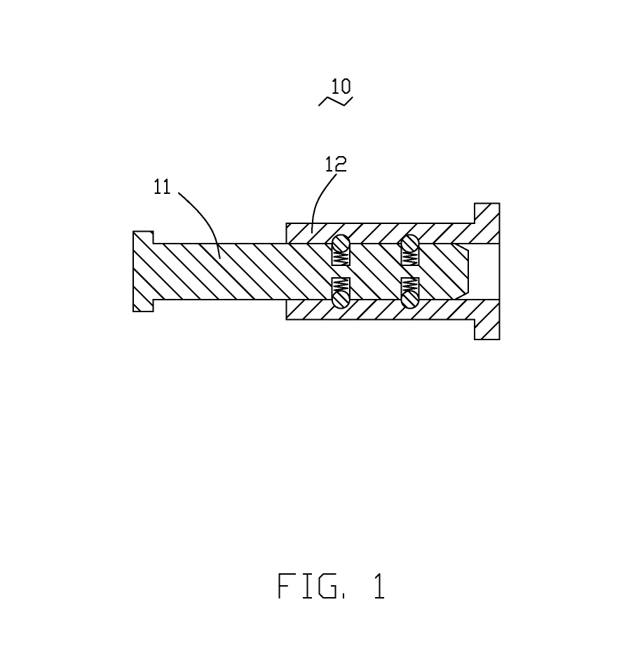

Referring to FIG. 1, a mold locking device 10 according to a first preferred embodiment of the present invention is shown. The mold locking device 10 includes a leader pin 11 and a leader pin bushing 12. The leader pin 11 includes at least one receiving hole 111 defined in an outer surface thereof and at least one spring-loaded ball bearing 112 received in the at least one receiving hole 111. The leader pin 11 is positioned in the leader pin bushing 12. The spring-loaded ball bearing 112 is placed between the leader pin 11 and the leader pin bushing 12.

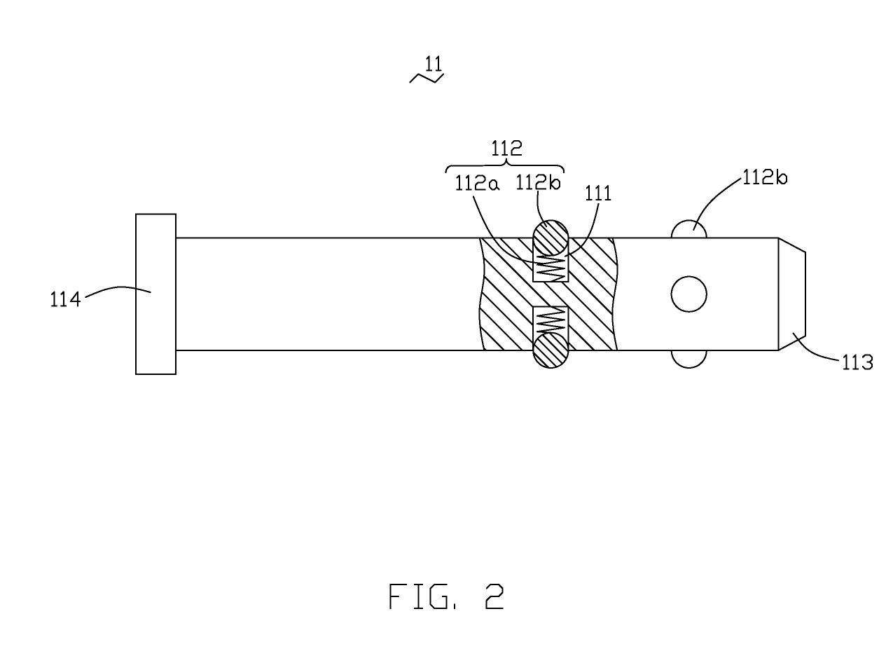

Referring to FIG. 2 showing the leader pin 11 in detail, the at least one spring-loaded ball bearing 112 includes a coil spring 112a and a ball bearing 112b secured to the coil spring 112a. The coil spring 112a is received in the at least one receiving hole 111. The coil spring 112a has one end connected with the leader pin 11 and the other end connected with the ball bearing 112b. A portion of the ball bearing 112b extends beyond the outer surface of the leader pin 11 protrusive. The coil spring 112a can be replaced by any elastic elements, such as recovery rubber gasket. The ball bearing 112b can be a steel ball or any hard ball. A height of the protrusive portion of the ball bearing 112b is smaller than a radius of the ball bearing 112b. The ball bearing 112b can be pushed into the at least one receiving hole 111 totally when a force is exerted thereon.

A diameter of the at least one receiving hole 111 is equal to the largest diameter of the at least one spring-loaded ball bearing 112. A depth of the at least one receiving hole 111 is shorter than a length of the at least one spring-loaded ball bearing 112 in an un-pressed condition. The depth of the at least one receiving hole 111 is equal to or shorter than the length of the at least one spring-loaded ball bearing 112 in a pressed condition. In the first preferred embodiment of the present invention, the at least one receiving hole 111 includes a number of receiving holes arranged evenly in the outer surface of the leader pin 11. The leader pin 11 further includes a leading angle 113 and a leader pin nut 114 for being placed into the leader pin bushing 12 more conveniently.

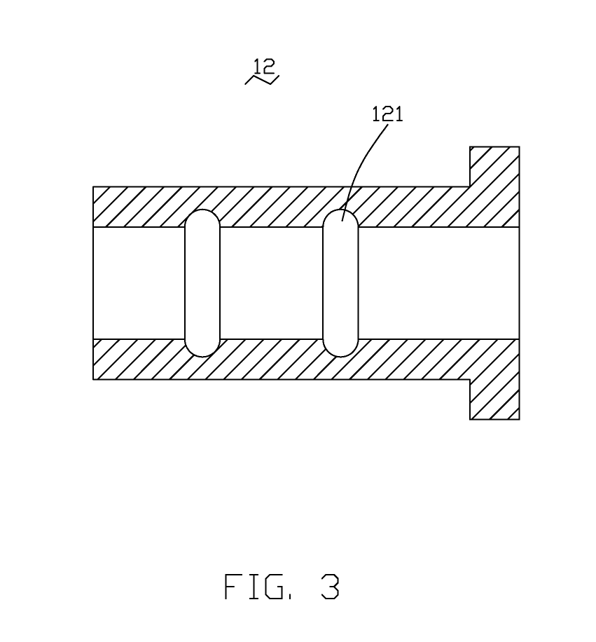

Referring to FIG. 3 showing the leader bushing 12 in detail, the leader pin bushing 12 is used for insertion of the leader pin 11 therein. The leader pin bushing 12 further includes a groove 121 defined in an inner surface for receiving the portion of the at least one spring-loaded ball bearing 112 (also referring to FIG. 1 and FIG. 2). The groove 121 is circular around the inner surface of the bushing 33 with a cross-section conforming to a shape of the ball bearing 112b. The ball bearing 112b can be pushed into the groove 121 by the coil spring 112a. A width of the groove 121 is larger than the diameter of the protrusive portion of the ball bearing 112b. The sizes of the leader pin bushing 12 and the leader pin 11 are matched to each other.

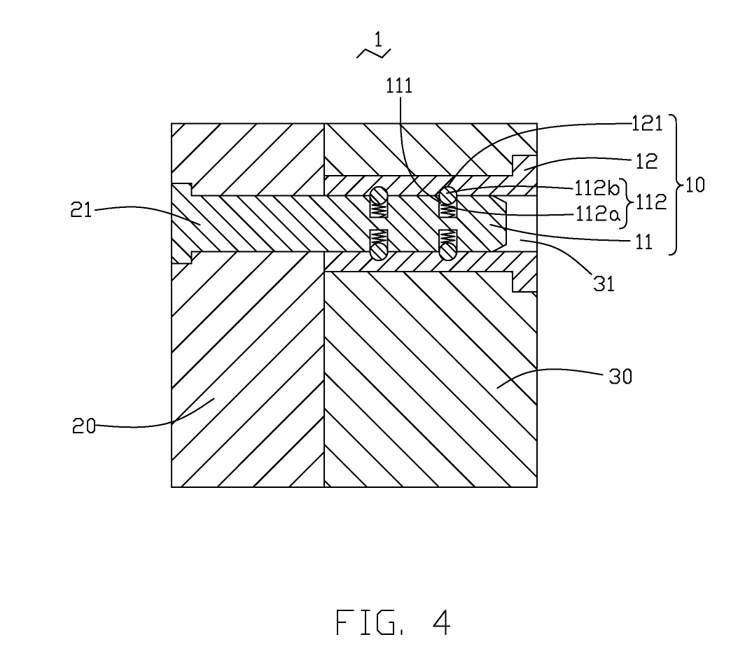

Referring to FIG. 4, a mold using the above-described mold locking device 10 according to a second preferred embodiment of the present invention is shown. The mold 1 includes a male mold part 20, a female mold part 30 and the mold locking device 10. The mold locking device 10 includes a leader pin 11 and a leader pin bushing 12. The leader pin 11 includes at least one receiving hole 111 defined in an outer surface thereof and at least one spring-loaded ball bearing 112 received in the at least one receiving hole. A portion of the at least one spring-loaded ball bearing 112 extends beyond the outer surface of the leader pin 11. The leader pin bushing 12 is used for insertion of the leader pin 11 therein. The leader pin bushing 12 further includes a groove 121 defined in an inner surface for receiving the portion of the at least one spring-loaded ball bearing 112.

The male mold part 20 defines a through hole 21 therein for extension of the leader pin 11 there through. The female mold part 30 defines a hole 31 therein for accommodating the leader pin bushing 12 therein. An inner diameter of the leader pin bushing 12 is equal to a diameter of the leader pin 11. Also referring to FIG. 2 and FIG. 3, the ball bearing 112b can be push back into the at least one receiving hole 111 when the leader pin 11 and the spring-loaded ball bearing 112 go through the hole of the male mold part 21. Until the spring-loader ball bearing 112 faces towards the groove 121, the ball bearing 112b can be pushed towards the groove 121 because of a recovery force of the coil spring 112a.

The male mold part 20 and the female mold part 30 are guided by the mold locking device 10 during closing and opening processes. Because the spring-loaded ball bearing 112 can temporarily keep the mold 1 at rest in a certain position, the mold locking device 10 can delay the opening process.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A mold locking device, comprising:
a leader pin comprising at least one receiving hole defined in an outer surface thereof, and at least one spring-loaded ball bearing received in the at least one receiving hole, a portion of the at least one spring-loaded ball bearing extending beyond the outer surface; and
a leader pin bushing for insertion of the leader pin therein, the leader pin bushing comprising a groove defined in an inner surface for receiving the portion of the at least one spring-loaded ball bearing.

2. The mold locking device as claimed in claim 1, wherein the at least one receiving hole includes a plurality of receiving holes arranged evenly in the outer surface of the leader pin.

3. The mold locking device as claimed in claim 1, wherein the spring-loaded ball bearing comprises a coil spring and a ball bearing secured to the coil spring.

4. The mold locking device as claimed in claim 3, wherein the ball bearing is a steel ball.

5. The mold locking device as claimed in claim 3, wherein the coil spring is received in the receiving hole; the coil spring having one end connected with the leader pin and the other end connected with the ball bearing.

6. The mold locking device as claimed in claim 3, wherein a majority of the ball bearing is received in the receiving hole.

7. The mold locking device as claimed in claim 1, wherein the groove is a circular groove with a cross-section conforming to a shape of the ball bearing.

8. A mold, comprising:
a male mold part;
a female mold part; and
a mold locking device comprising:
a leader pin comprising at least one receiving hole defined in an outer surface thereof, and at least one spring-loaded ball bearing received in the at least one receiving hole, a portion of the at least one spring-loaded ball bearing extending beyond the outer surface; and
a leader pin bushing for insertion of the leader pin therein, the leader pin bushing embedded in at least one of the male mold part and the female mold part and comprising a groove defined in an inner surface thereof for receiving the portion of the at least one spring-loaded ball bearing.

9. The mold as claimed in claim 8, wherein the male mold part defines a through hole therein for extension of the leader pin there through.

10. The mold as claimed in claim 8, wherein the female mold part defines a hole therein for accommodating the leader pin bushing therein.
